(19) United States
(12) Patent Application Publication
(10) Pub. No.: US 2015/0134751 A1
(43) Pub. Date: May 14, 2015

(54) SHARING A FILE VIA EMAIL

(71) Applicant: Microsoft Corporation, Redmond, WA (US)

(72) Inventors: David Lloyd Meyers, Jr., Bellevue, WA (US); David Paul Limont, Seattle, WA (US); Kenneth Fern, Bellevue, WA (US); Michael Palmer, Edmonds, WA (US); Betsy Yu-pui McIntyre, Redmond, WA (US); Mirela Correa, Redmond, WA (US)

(73) Assignee: Microsoft Corporation, Redmond, WA (US)

(21) Appl. No.: 14/079,137

(22) Filed: Nov. 13, 2013

(51) Int. Cl. H04L 12/58

(52) U.S. Cl. CPC H04L 51/08
USPC 709/206

(57) ABSTRACT

Techniques for facilitating sharing a file via email are disclosed. A file may be shared as an attachment or link in a simplified process flow initiated from within an email application. In response to receiving a command to share a file, the email application can launch a file explorer screen from which a user may navigate files including files stored on a local drive and files stored via a cloud storage provider. After a file is selected by the user via the file explorer screen the email application can present sharing options for the file. Regardless of where the file is originally stored, the file may be attached to the email or a link to the file may be inserted in the email. The email application can upload a file from a local drive to the cloud storage provider when such a file is selected for inserting as a link.

### BACKGROUND

When users wish to share files (e.g., documents of various file types) with other users, they often attach a copy of the file to an electronic message. Typically, a user can attach a file from within an email application using an “attach” file menu command that launches a file chooser, enabling the user to select a file from the user's local computer or network server. Increasingly, however, users store their files using internet-based storage services (often called “cloud storage”) which serve as a centralized (even if physically distributed), accessible repository for the files. For files stored in “the cloud,” the user may either share from within the cloud service or obtain a link URL from the cloud service and insert the URL into the body of the message manually.

However, these existing methods of sharing files require the user sending the email to have decided, in advance, where the files are located and how they will be shared. Such a workflow can be inefficient and frustrating to the user sending the file, as users may compose their message to the recipient before considering the precise storage locations of the files they wish to share.

### BRIEF SUMMARY

A process flow and interface for sharing a file via email is described. A user who wants to share a file using email is provided with a simplified entry point and process flow for selecting a file and copying the file as an attachment or inserting a link to the file.

A user interface is provided that guides a user through a sequence of steps to share a file from any of multiple file storage locations (e.g., local, network, or cloud storage provider) in a desired manner (e.g., as an attachment or as a link) while preparing an email within an email client. A single entry point is provided for attaching a file or inserting a link to a file. The single entry point may be a command icon that first allows a user to select a file from any of multiple file storage locations before a decision by the user is made as to the form of sharing in the email. That is, after a file or files are selected by a user, an option surfaces for how the file or files can be shared. The options may include attaching a copy to the email and inserting a link into the email.

Although email is discussed in detail, other communication modalities, such as instant message (SMS, MMS), may incorporate the described process flow.

In some embodiments, while within an email client, the user may copy files between a cloud storage provider and the user's local computing device. In some cases, when generating a link, a file that is stored on the user's local computing device may be uploaded to a cloud storage provider. Multiple file selection and mixed-mode file sharing options are also implemented in some scenarios.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates a process flow diagram for sharing a file in an electronic messaging application, in which files can be selected from a storage device and attached as links or as copies to an electronic message.

FIGS. 2A, 2B, 3, 4A, 4B, and 5 illustrate example user interfaces of a process flow for sharing a file.

FIG. 6 illustrates a further process flow according to an example implementation for when a file from a local drive (or other than cloud storage drive) is selected.

FIG. 7 illustrates a further process flow according to an example implementation for when a file from a cloud storage drive is selected.

FIG. 8 is a block diagram illustrating components of a computing device or system used in some embodiments.

FIG. 9 depicts an architecture in which several computing devices are networked.

FIG. 10 illustrates example system architectures in which embodiments may be carried out.

### DETAILED DESCRIPTION

A process flow and interface for sharing a file via email is described. A user who wants to share a file using email is provided with a simplified entry point and process flow for selecting a file and copying the file as an attachment or inserting a link to the file.

Although email clients are specifically described herein for implementing the file sharing process flow, other messaging services and modalities, such as instant messaging (SMS, MMS), may also implement the file sharing process flow. Thus, embodiments may be implemented in a variety of electronic messaging applications.

For example, embodiments can be implemented as part of any software or firmware which provides electronic messaging services to an end-user. An “electronic messaging application” refers to any application or user interface which allows the sending of electronic messages (such as email) to other recipients over local networks or internetworks.

Although embodiments are described as providing methods and systems for file sharing, both files (individual items containing data and even compressed files that contain data from multiple items) and folders (a container that can contain multiple files and even other folders) may be shared.

Embodiments described herein enable a user who is composing an email to select what to share and then how to share it in a simplified and seamless manner. The simplified entry point and process flow allows a user to select what to share and then how to share it by making multiple file locations, including cloud storage, available for picking a file from within an email client and then providing the option for either attaching the file to the message or including a link to the file in the message. This enables a user to not only delay the decision of how information is going to be sent to one or more recipients until after the selection of the file is made, but to also access their cloud storage (or other document repository) from inside the email client when inserting a file as a link. In this manner, a user does not need to leave the email client to generate a link.

A link refers to a word, group of words, or image that can be used, when “clicked,” to jump to another document. The link includes, as one of its attributes, a uniform resource locator (URL) indicating the source of the document (e.g., the destination of the jump). The email client can obtain the URL in any suitable manner. According to certain implementations, a URL can be received by the email client for use in generating the link in the message. In some cases, the email client can request, via an application programming interface (API), a cloud storage provider or other content managing server (that manages the storage and/or organization of stored content) to generate the URL for a file. In other cases, the email client can generate the URL for a file, for example when the email client includes a file manager that manages a file storage for the file.

A “storage provider” can be understood to mean any provider of permanent or semi-permanent media space upon which to save and load files and documents. A storage provider can include cloud storage providers.

“Cloud storage” is a type of networked storage where data is stored in virtualized pools of storage, spanning across multiple servers and multiple locations. These networked storage pools are often operated by companies with large data centers, such as Amazon.com Inc. or Google Inc. End users and companies may then lease storage capacity from them. The purchasers of these storage pools connect to them using the internet or, less frequently, over private networks.

“Cloud storage providers” are companies which provide cloud storage services to end-user consumers. These companies enhance the ease of interaction with the cloud storage pools by providing applications on various computing platforms such as desktop computers, tablets, and smartphones. Some examples of cloud storage providers are Microsoft SkyDrive®, Google Drive™, Box™, and Dropbox™. Typically, cloud storage providers install applications on the local device. These applications integrate with the remote cloud storage devices to explore, upload, and synchronize files. These services also typically have a web browser interface to the stored files which allows the user to control them when the provider's interface application is not installed on the local device.

An email client refers to a program that enables a user to access the user's email. The email client may be a local application running on the user's computing device or a web application accessed by the user via a browser running on the user's computing device.

Example email clients that may implement the process flow described herein include, but are not limited to, Microsoft Outlook®, IBM Lotus Notes®, Apple® Mail, Google Gmail®, Outlook.com, and Yahoo!® Mail. Email and other electronic messaging services are often incorporated into personal information managers which provide additional services such as calendaring, task management, and contact management.

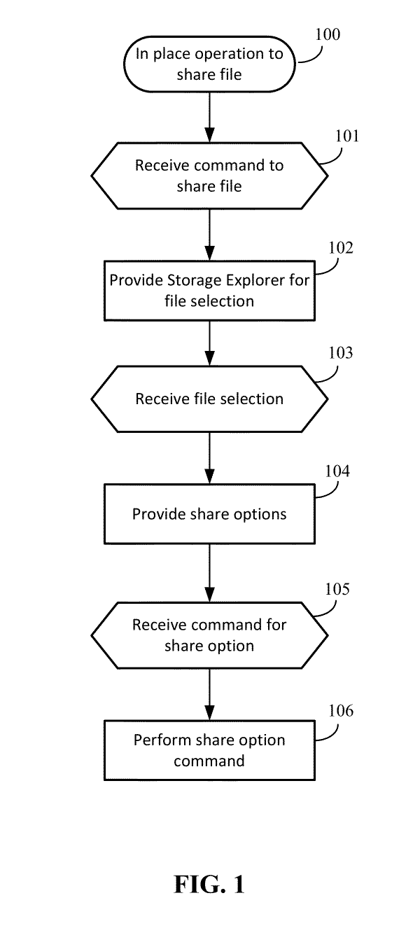

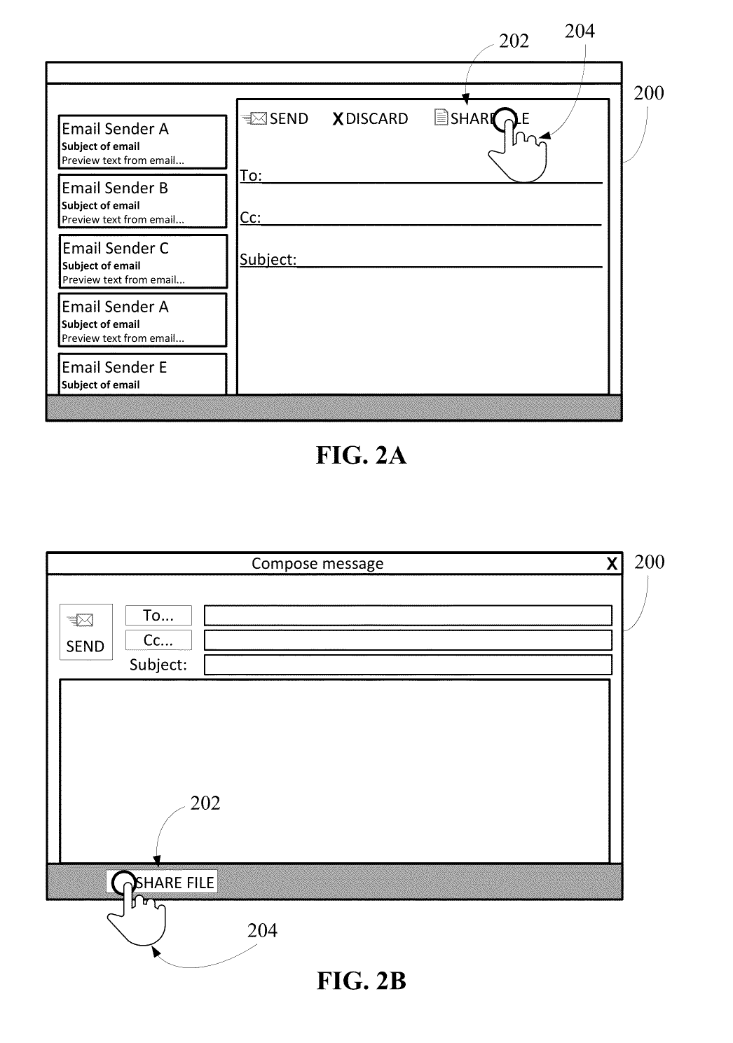

FIG. 1 illustrates a process flow diagram for sharing a file in an electronic messaging application, in which files can be selected from a storage device and attached as links or as copies to an electronic message. FIGS. 2A, 2B, 3, 4A, 4B, and 5 illustrate example user interfaces of a process flow for sharing a file.

In FIG. 1, the invocation of a command to “share a file” initiates share process flow (100). Although reference is made to sharing a file, implementations can include the sharing of folders as well as the file(s) contained in the folders. Therefore, when an aspect is discussed related to sharing a file, it should be understood that some implementations may also enable that aspect or feature to apply to sharing a folder.

FIGS. 2A and 2B illustrate two example representations of a compose message screen interface 200, in which a user may compose a message and attach or include other files while within an electronic messaging application running directly on or indirectly via a browser running on a computing device. The user's computing device may be, but is not limited to, a personal computer, a laptop computer, a desktop computer, a tablet computer, a reader, a mobile device, a personal digital assistant, a smart phone, a gaming device or console, or a smart television.

As shown in FIGS. 2A and 2B, a share a file command 202 may be presented to initiate a share process flow as a single entry point. A user may click or touch (204) the command 202 to launch the share process flow.

The “share a file” command can be considered similar to “attach a file” in this user context as a launch, or entry, point for the share process flow. The precise labeling of the user interface feature may vary by implementation, but includes any entry point for launching a process flow that enables a user to include a link to or a copy of a file for sharing the file with a recipient.

It should be noted that, while the command 202 is depicted as part of a new message composition surface, the same command is also applicable to a “reply” or “forward” composition surface. It should also be noted that many other user interface elements, as diverse as drop-down menus, right-click context menus, or even voice commands, may be utilized to initiate the file sharing process. Furthermore, as those skilled in the art will recognize, the determination that a user input command has occurred can be performed using any suitable detection method supported by an operating system or software development kit. Accordingly, the command may be, but is not limited to, a voice command, gestural command (touch or non-touch), touch command, or click command.

Returning to FIG. 1, in response to the receipt of the command to share a file (101), a user interface feature depicting storage provider and file selection locations can be provided (102). This user interface feature can include a file explorer screen depicting the various storage provider options available to the user.

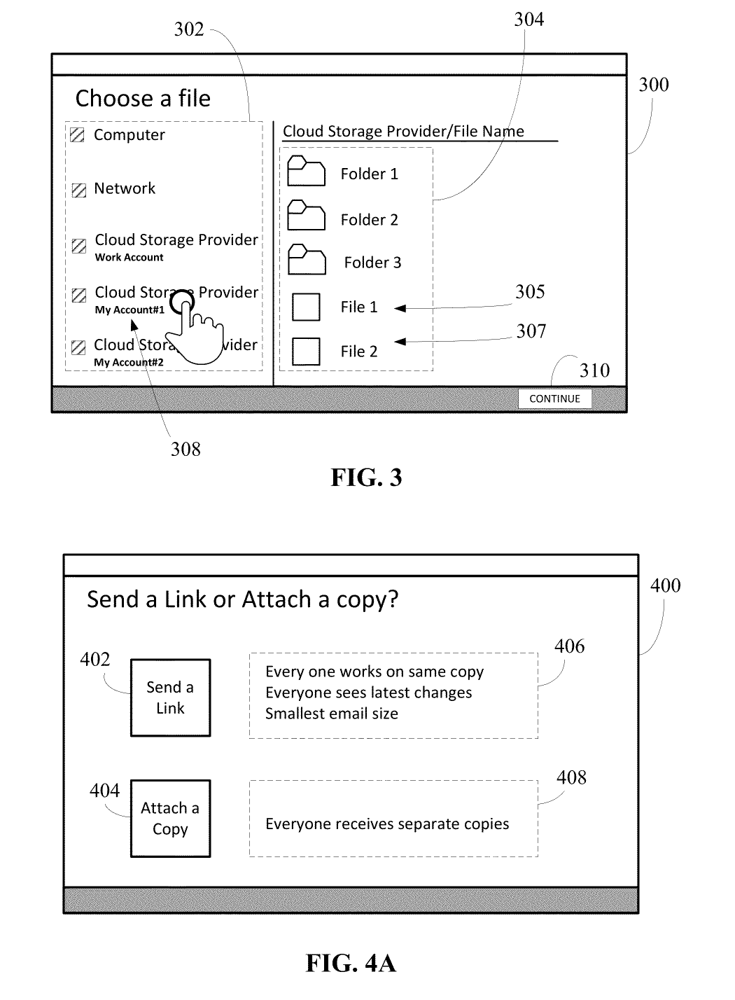

FIG. 3 illustrates an example representation of a file explorer screen interface. From within the file explorer screen interface 300, a user may navigate files and choose the individual file(s) to share. The file explorer screen interface 300 may open in a new window separate from the composition surface, or may open in a same window. One or more storage locations (and providers) 302, may be depicted, allowing the user to use the view for the file explorer screen interface 300 to navigate the folders and files (via explorer display 304) present in these locations.

The storage locations exposed by the providers 302 may include devices attached to the local computer (such as the “C drive”), SD Cards, USB sticks, and CD/DVD-ROM drives. In addition, these locations include network drives such as those available to users over a shared network accessible via a local-area network, wide-area network, or virtual private network. The storage locations exposed by the providers 302 also include cloud storage providers. Available cloud storage providers may be discoverable by and accessible to an electronic messaging application in any number of ways implemented by the underlying device operating system, or by programming frameworks layered atop it, including but not limited to an application programming interface (API) or registry setting.

As the user navigates through the various storage providers 302, the perspective depicted in the explorer display 304 changes, displaying the folders and files available on that storage provider. The user may then select one file or multiple files (and in some cases a folder) for sharing by interacting with the interface using any number of methods, including but not limited to pressing a checkbox next to the file (or folder), pressing on the line to select the line, or swiping the file (or folder) with a finger on a touchscreen. The act of selecting one or more items in this way is known as “multi-selection,” and it enables the application to perform the same operation on many items of the same type.

One or more files (e.g., file 1 305 and file 2 307 from cloud storage 308 as shown in FIG. 3) may be selected for sharing. In some cases, as soon as a file is selected, the process flow proceeds to the next step. In other cases, once one or more files are selected, the user may indicate to proceed to the next step in the process flow (for example, via a “continue” command 310). Other embodiments of the generalized motif of proceeding or cancelling are possible. The indication of a selection of a file and/or the indication of the command to continue can cause the application to receive a file selection.

Returning to FIG. 1, in response to receiving a file selection (103), a user interface element (e.g., a sharing option screen) depicting sharing options can be provided (104).

It should be understood that, in this context, a “sharing option” can mean sharing by attaching a complete copy of the file to the email, or sharing a pointer (or URL) to the file (or folder) residing in a centralized storage location. However, it can also mean other methods of sharing not necessarily connoted by literal uses of the words “copy” or “link”. Various embodiments may use the words “copy,” “link,” or other terms to depict methods of sharing.

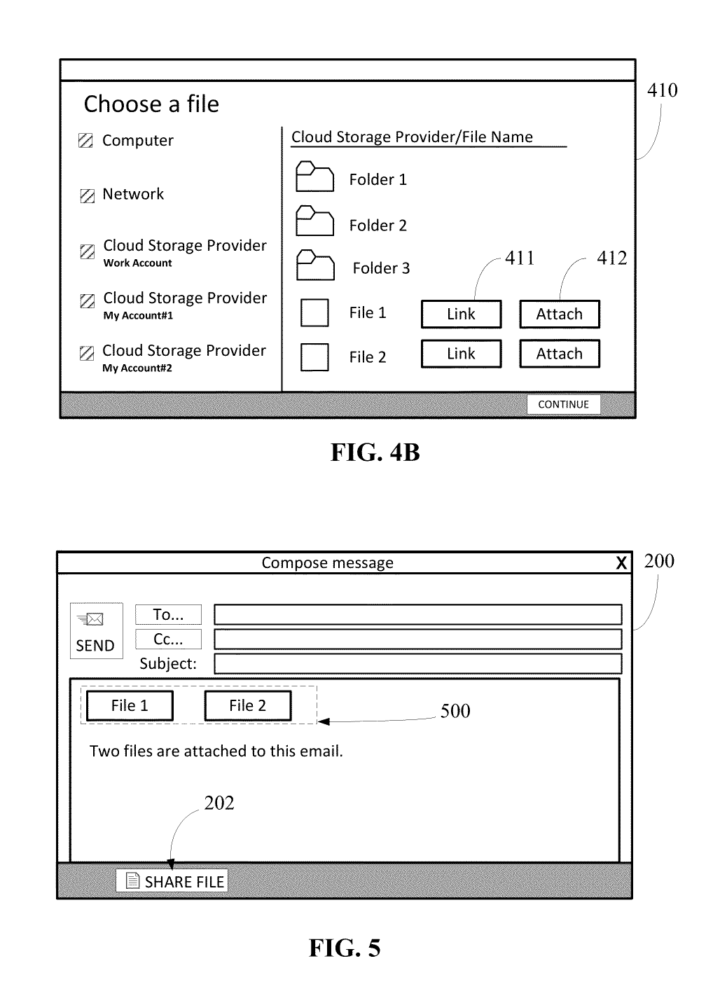

FIGS. 4A and 4B illustrate two example implementations for surfacing the sharing options. FIG. 4A illustrates a view 400 of a sharing options screen following the file explorer screen interface 300, where a user may choose the method of sharing the selected file(s).

The user may select a “send a link” button 402 or “attach a copy” button 404 to initiate the operation. In the non-limiting implementation illustrated in FIG. 4A, descriptive text 406, 408 may assist the user in deciding which method to use.

Instead of a separate view (as shown in FIG. 4A), the navigation view (e.g., file explorer screen interface 300 of FIG. 3) may remain and have the sharing option command button(s) surfaced in response to a file selection. For example, referring to FIG. 4B, once a file is selected, the sharing options interface elements “link” 411 and “attach” (or copy) 412, surface alongside each filename, enabling the user to select the desired operation on a per-file basis as illustrated in view 410. Therefore, this interface allows multiple file selection with mixed sharing modes; a link, an attached copy, or both, may be chosen by the user as the method of sharing each file.

In various embodiments, the sharing element (411 or 412) may display to the user a signal indicating the modes of sharing which were selected for each file. This signal can be depicted in a variety of ways, including but not limited to changing color, changing texture, displaying a check-mark, displaying a recessed look, displaying text, or changing the icon. Other signals are possible.

When the user has completed the file selection and mode of sharing selection in view 410, the user may select an interface feature to complete or cancel the operation. In the illustrated example shown in FIG. 4B, a “continue” command to complete the operation is shown. In some cases, selection of either sharing element will indicate completion of selection.

Returning to FIG. 1, after the user has selected the desired sharing option and a command for instantiating the sharing option has been received by the application platform (105), the application platform performs the requested command (106). When the desired command is selected by the user, the electronic messaging application inserts or attaches to the message a link or copy of the selected files. FIG. 5 illustrates an example view of a compose message surface (such as surface 200) in which two files 500 have been attached. The two files 500 may have been attached in a single process flow; or the user may return through the flow by using the share file command 202 for each file to attach or insert as a link (e.g., following process flow 100).

Once a copy of the file or a link to the file on the storage provider has been attached to the electronic message, the sender may complete and send the electronic message. Completion of the electronic message may involve, for example, inputting header information such as the recipients' e-mail address(es), a subject description, composing the text of the message body. Finally, the user may send the message or save the message as a draft, as is well known in the art.

In various embodiments, as part of completing a “link” operation, a local file may be uploaded, either automatically or after requesting permission from the user, to a cloud storage provider before the link is generated. It is also contemplated that an interface view displaying more than one upload option may be available, depending on the number of cloud storage providers to which the sending user subscribes and the level of integration of those providers. It should be noted that “uploading” is the term of art for copying or moving a file from local storage to a networked storage provider such as a cloud storage provider.

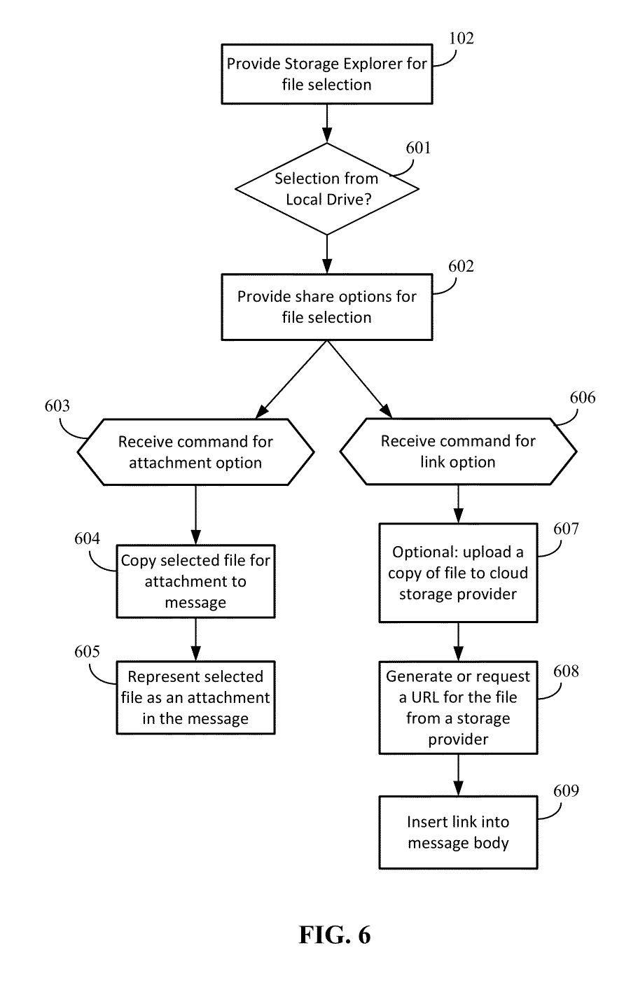

FIG. 6 illustrates a further process flow according to an example implementation for when a file from a local drive (or other than cloud storage drive) is selected. The process flow illustrated in FIG. 6 begins from step 102 described with respect to FIG. 1. In response to receiving a selection of a file from a local drive (or other than cloud storage drive) (601), a user interface element depicting sharing options can be provided (602). As with an expected process flow for attaching a file, in response to receiving a command for the attachment option (603), the selected file is copied for attachment to the message (604) and a representation of the selected file as an attachment is included in the message (605).

However, in response to receiving a command for a link option (606), a user can be presented with an option to upload a copy of the file to cloud storage while within the email application and process flow (607). This enables a link to be generated by the cloud storage provider and make the link accessible in a manner that may not be possible if the file remains at the user's local drive (or even if it remains at the user's networked drive). A URL for the file (uploaded now to the cloud storage provider) may be generated or requested (and received) from the storage provider (608); and the link inserted into the message body (609).

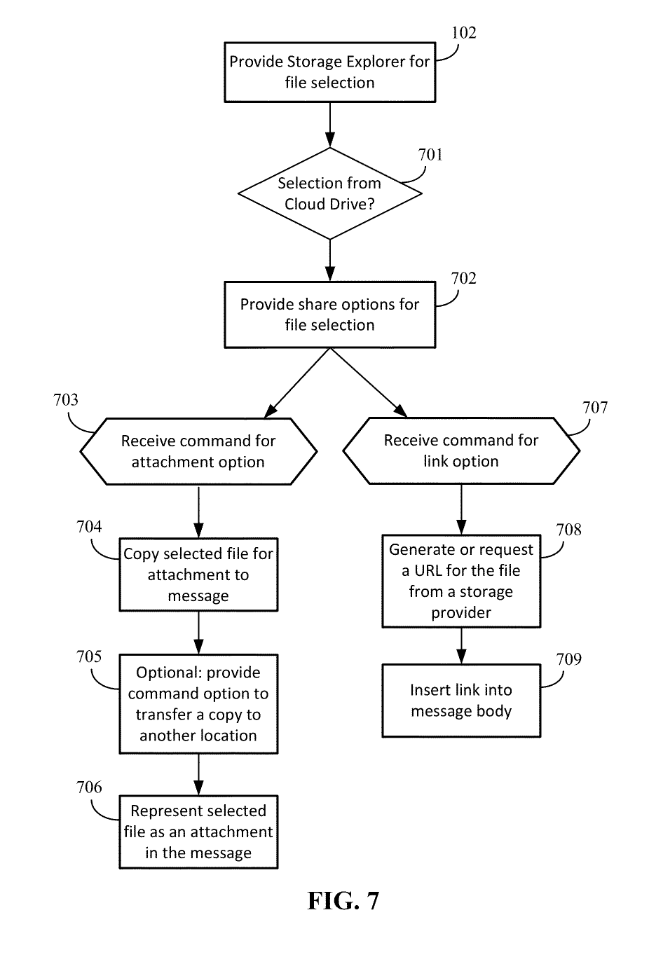

FIG. 7 illustrates a further process flow according to an example implementation for when a file from a cloud storage drive is selected. The process flow illustrated in FIG. 7 begins from step 102 described with respect to FIG. 1. In response to receiving a selection of a file from a cloud storage provider (701), a user interface element depicting sharing options can be provided (702). In response to receiving a command for the attachment option (703), the selected file is copied for attachment to the message (704). Since the file is copied, optionally, a command option can be provided to transfer a copy of the file to another location selected by the user (705). For example, the user may, while within the email client, copy a file from their cloud storage provider to a local drive. For the email, the copied file can be represented as an attachment in the message (706).

In response to receiving a command for a link option (707), a URL for the file may be generated or requested (and received) from the storage provider (708) and the link inserted into the message body (709). Advantageously, a user does not need to leave the email client in order to get a URL for the file to share.

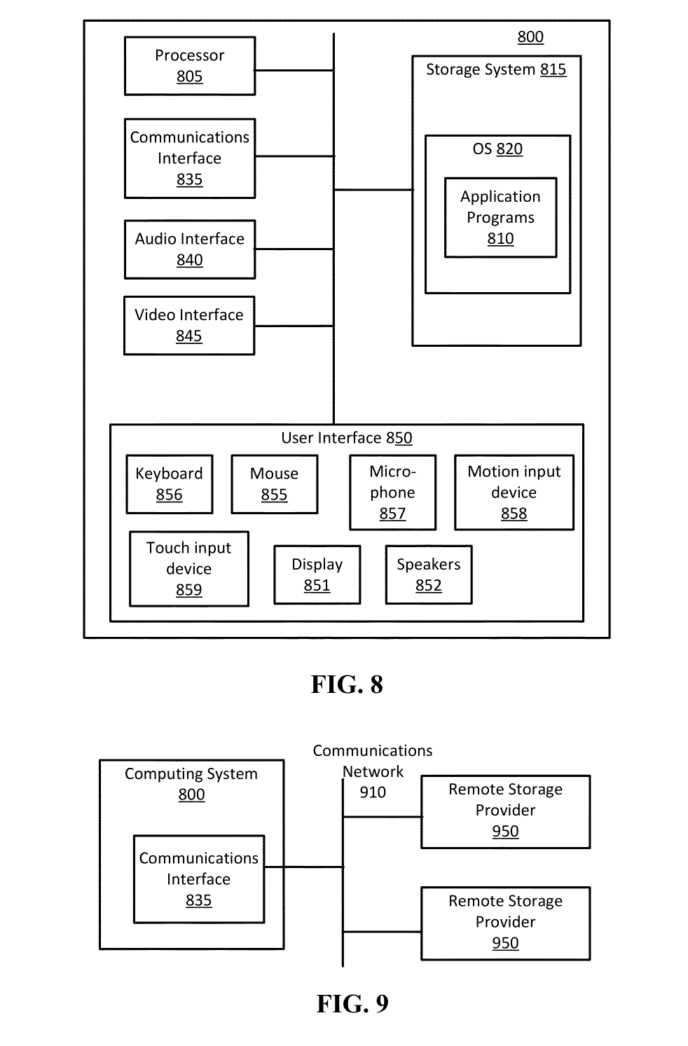

FIG. 8 shows a block diagram illustrating components of a computing device used in some embodiments. System 800 may be implemented within a single computing device or distributed across multiple computing devices or sub-systems that cooperate in executing program instructions. System 800 can be used to implement myriad computing devices, including but not limited to a personal computer, a tablet computer, a reader, a mobile device, a personal digital assistant, a smartphone, a laptop computer (notebook or netbook), a gaming device or console, a desktop computer, or a smart television. Accordingly, more or fewer elements described with respect to system 800 may be incorporated to implement a particular computing device.

System 800, for example, includes a processor 805 which processes data according to the instructions of one or more application programs 810 interacting with the device operating system (OS) 820. Examples of processers for the processor 805 include general purpose central processing units, application specific processors, and logic devices, as well as any other type of processing device, combinations, or variations thereof.

The application programs 810, OS 820 and other software may be loaded into and stored in a storage system 815. Device operating systems 820 generally control and coordinate the functions of the various components in the computing device, providing an easier way for applications to connect with lower level interfaces like the networking interface. Non-limiting examples of operating systems include Windows® from Microsoft Corp., IOS™ from Apple, Inc., Android™ OS from Google, Inc., Windows™ RT from Microsoft, and the Ubuntu variety of the Linux OS from Canonical.

It should be noted that the OS 820 may be implemented both natively on the computing device and on software virtualization layers running atop the native Device OS. Virtualized OS layers, while not depicted in FIG. 8, can be thought of as additional, nested groupings within the OS 820 space, each containing an OS, application programs, and APIs.

Storage system 815 may comprise any computer readable storage media readable by the processor 805 and capable of storing software (e.g., application programs 810 and OS 820).

Storage system 815 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the storage media a propagated signal. In addition to storage media, in some implementations storage system 815 may also include communication media over which software may be communicated internally or externally. Storage system 815 may be implemented as a single storage device but may also be implemented across multiple storage devices or sub-systems co-located or distributed relative to each other. Storage system 815 may comprise additional elements, such as a controller, capable of communicating with processor 805.

Software may be implemented in program instructions and among other functions may, when executed by system 800 in general or processor 805 in particular, direct system 800 or processor 805 to operate as described herein for the share process flow via email (e.g., process flow 100). Software may include additional processes, programs, or components, such as operating system software or other application software. Software may also comprise firmware or some other form of machine-readable processing instructions executable by processor 805.

In general, software may, when loaded into processor 805 and executed, transform computing system 800 overall from a general-purpose computing system into a special-purpose computing system customized to facilitate a share process flow as described herein for each implementation. Indeed, encoding software on storage system 815 may transform the physical structure of storage system 815. The specific transformation of the physical structure may depend on various factors in different implementations of this description. Examples of such factors may include, but are not limited to the technology used to implement the storage media of storage system 815 and whether the computer-storage media are characterized as primary or secondary storage.

For example, if the computer-storage media are implemented as semiconductor-based memory, software may transform the physical state of the semiconductor memory when the program is encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate this discussion.

It should be noted that many elements of system 800 may be included in a system-on-a-chip (SoC) device. These elements may include, but are not limited to, the processor 805, communications interface 835, audio interface 840, video interface 845, and storage system 815.

Communications interface 835 may include communications connections and devices that allow for communication with other computing systems over one or more communication networks (not shown). Examples of connections and devices that together allow for inter-system communication may include network interface cards, antennas, power amplifiers, RF circuitry, transceivers, and other communication circuitry. The connections and devices may communicate over communication media (such as metal, glass, air, or any other suitable communication media) to exchange communications with other computing systems or networks of systems. Transmissions to and from the communications interface are controlled by the OS 820, which informs applications and APIs of communications events when necessary.

In various implementations, data or programming instructions utilized by system 800 may be stored on the computing device. However, as illustrated in FIG. 9, data or programming instructions may also be stored on any number of remote storage platforms 950 that may be accessed by the device over communication networks 910 via the communications interface 835. Such remote storage providers might include, for example, a server computer in a distributed computing network, such as the Internet. They may also include “cloud storage providers” whose data and functionality are accessible to applications through OS functions or APIs.

User interface 850 may include input devices such as a mouse 855, track pad, keyboard 856, microphone 857, a touch device 859 for receiving a touch gesture from a user, a motion input device 858 for detecting non-touch gestures and other motions by a user, and other types of input devices and their associated processing elements capable of receiving user input.

Output devices such as display screens 851, speakers 852, haptic devices for tactile feedback, and other types of output devices may be included in user interface 850. In certain cases, the input and output devices may be combined in a single device, such as a touchscreen display which both depicts images and receives touch gesture input from the user. Visual output may be depicted on the display 851 in myriad ways, presenting graphical user interface elements, text, images, video, notifications, virtual buttons, virtual keyboards, or any other type of information capable of being depicted in visual form. Other kinds of user interface are possible. User interface 850 may also include associated user interface software executed by the OS 820 in support of the various user input and output devices. Such software assists the OS in communicating user interface hardware events to application programs 810 using defined mechanisms.

It should be understood that computing system 800 is generally intended to represent a computing system with which software is deployed and executed in order to implement a messaging application with a share process flow as described herein. However, computing system 800 may also represent any computing system on which software may be staged and from where software may be distributed, transported, downloaded, or otherwise provided to yet another computing system for deployment and execution, or yet additional distribution.

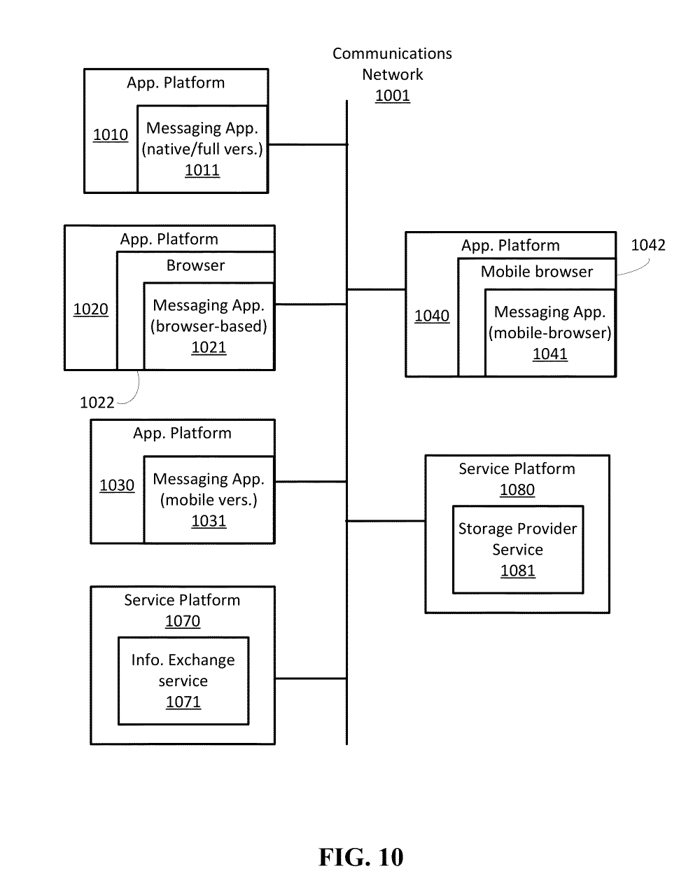

FIG. 10 illustrates an application environment 1000 in which an electronic messaging application with the proposed improvements may be implemented utilizing the principles depicted in system 800 (FIG. 8) and discussed above. In particular, FIG. 10 shows various application platforms 1010, 1020, 1030, and 1040, each of which is capable of communicating with service platforms 1070 and 1080 over communications network 1001 to exchange messages and access storage devices. The application platforms 1010, 1020, 1030, and 1040 may be any computing apparatus, device, system, or collection thereof employing a computing architecture suitable for implementing the electronic messaging application (1011, 1021, 1031, 1041) on that platform.

Messaging application 1011 may be considered a full or “native” version that is locally installed and executed. In some cases, messaging application 1011 may operate in a hybrid manner whereby a portion of the application is locally installed and executed and other portions are executed remotely and then streamed to application platform 1010 for local rendering. Non-limiting examples of messaging application 1011 include Microsoft Outlook® and Mozilla Thunderbird™.

Messaging application 1021, implemented on application platform 1020, may be considered a browser-based version that is executed wholly or partly in the context of a browser application 1022. In this model, all or part of the programming instructions are executed remotely and the browser application 1022 renders the result to the user's device through a visual expression language such as HTML. Non-limiting examples of messaging application 1021 include Outlook.com™, Gmail.com™, and Microsoft® Outlook Web App (OWA). Examples of the browser application 1022 include Google Chrome™, Microsoft Internet Explorer™, and Mozilla Firefox™.

Messaging application 1031 may be considered a mobile application version that is locally installed and executed on a mobile device. In some cases, messaging application 1031 may operate in a hybrid manner whereby a portion of the application is locally installed and executed and other portions are executed remotely and then streamed to application platform 1030 for local rendering. Non-limiting examples of mobile messaging applications 1031 include the Outlook.com App and the Gmail App.

Messaging application 1041, implemented on application platform 1040, may be considered a browser-based version that is executed wholly or partly in the context of a mobile browser application 1042. In this model, all or part of the programming instructions are executed remotely and the mobile browser application 1042 renders the result to the user's device through a visual expression language such as HTML. Non-limiting examples of a mobile browser messaging application 1041 include mobile-device-enhanced views of content through Outlook.com™, Gmail™ and the Microsoft® Outlook Web App (OWA). Examples of the mobile browser application 1042 include Google Chrome™ and Mozilla Firefox™.

The application platforms 1010, 1020, 1030, and 1040 may communicate with service platforms 1070 and 1080 connected by network 1001. Service platforms may deliver a variety of services useful to the application platforms and messaging applications. For example, service platform 1070 may deliver information exchange service 1071 which enables the routing of electronic message content. Service 1071 may also host remote programming instructions and render their results to messaging applications or browsers on any of the application platforms. Non-limiting examples of information exchange service 1071 include Microsoft® Exchange Server, Microsoft Office365™, Outlook.com™, and Gmail™.

In addition, service platform 1080 may deliver storage provider service 1081, which enables non-local storage of files or other data which can be utilized by messaging applications 1011, 1021, 1031, and 1041. For example, storage provider service 1081 might be a cloud storage provider, a database server, or a local area network file server. Non-limiting examples of storage provider services include Microsoft SkyDrive®, Google Drive™, DropBox™, Box™, and Microsoft® SQL Server.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

It should be understood that the examples and embodiments described herein are for illustrative purposes only and that various modifications or changes in light thereof will be suggested to persons skilled in the art and are to be included within the spirit and purview of this application.

What is claimed is:

1. A computer-implemented method facilitating the sharing of one or more files via an electronic message, the method comprising:
in response to receiving a command to share a file from within a message application interface, displaying a file explorer screen from which a file may be selected; and
in response to receiving an indication of a selection of a file via the file explorer screen, displaying a first share option for copying a file as an attachment and a second share option for inserting a link to the file.

2. The method of claim 1, further comprising:
in response to receiving an indication of a selection of the first share option, copying the file to an electronic message as an attachment.

3. The method of claim 1, wherein the file explorer screen further enables selection of a folder, the method further comprising:
in response to receiving an indication of a selection of a folder via the file explorer screen, displaying a first option for copying a folder and its contents as an attachment and a second option for inserting a link to the folder.

4. The method of claim 1, wherein, in response to receiving an indication of the second share option for inserting a link to the file, requesting a uniform resource locator for the file from a cloud storage provider, wherein the cloud storage provider need not be separately launched by a user to request the link.

5. The method of claim 1, wherein, in response to receiving an indication of the second share option for inserting a link to the file when the file is a file from a local drive, uploading the file from the local drive to a cloud storage provider.

6. The method of claim 5, wherein, in response to receiving the indication of the second share option for inserting the link to the file, the method further comprises:
requesting a uniform resource locator for the file from the cloud storage provider after uploading the file from the local drive to the cloud storage provider.

7. The method of claim 1, wherein the message application interface comprises an interface for composing an email.

8. One or more computer-readable storage media having stored thereon computer-executable instructions for performing a method comprising:
rendering a compose message screen including a command to share a file.
in response to receiving an indication of a selection of the command to share a file, rendering a file explorer screen from which a user may navigate at least a local drive and a cloud storage drive and select at least one file; and
in response to receiving an indication of a selection of a file via the file explorer screen and only after receiving the indication of the selection of the file, displaying a first share option for copying a file as an attachment and a second share option for inserting a link to the file;
in response to receiving an indication of the first share option, copying the file as an attachment to a message being composed in the compose message screen; and
in response to receiving an indication of the second share option, inserting a link to the file in the message being composed in the compose message screen.

9. The media of claim 8, wherein displaying the first share option for copying a file as an attachment and a second share option for inserting a link to the file comprises rendering a share option screen comprising the first share option and the second share option.

10. The media of claim 9, wherein in response to an indication of a selection of a file from a local drive via the file explorer screen, the share option screen further comprises an option to upload a copy of the file to a cloud storage provider.

11. The media of claim 8, further having instructions stored thereon wherein, in response to receiving an indication of the second share option, the method further comprises:
uploading a copy of the file to a cloud storage provider when the file is selected from a local drive; and
requesting a uniform resource locator (URL) for the file from the cloud storage provider after uploading a copy of the file from the local drive to the cloud storage provider,
wherein the link to the file includes the URL.

12. The media of claim 8, wherein displaying the first share option for copying a file as an attachment and a second share option for inserting a link to the file comprises surfacing a first command for the first option and a second command for the second option on the file explorer screen.

13. The media of claim 8, further having instructions stored thereon wherein, in response to receiving an indication of the second share option, the method further comprises:
obtaining a uniform resource locator (URL) for the file, wherein the link to the file includes the URL.

14. The media of claim 13, wherein obtaining the URL comprises requesting the URL from a cloud storage provider, wherein the cloud storage provider need not be separately launched by a user.

15. The media of claim 8, wherein the file explorer screen further enables selection of a folder for sharing, the media further having instructions stored thereon for displaying the first share option and the second share option in response to receiving an indication of a selection of a folder for sharing.

16. The media of claim 8, wherein the message comprises an email message.

17. An apparatus comprising:
one or more computer readable storage media; and
an email application embodied in program instructions stored on the one or more computer readable media that, when executed by a computing system, direct the computing system to render a user interface to the email application, wherein the user interface includes a plurality of screens comprising:
a file explorer screen rendered in response to receiving a command to share a file, the file explorer screen enabling a user to navigate at least a local drive and a cloud storage drive while remaining within the email application and select a file for sharing via the email application; and
a sharing option screen rendered in response to a selection of a file via the file explorer screen, the sharing option screen including a first option to attach a copy of the file option and a second option to insert a link to the file.

18. The apparatus of claim 17, wherein the plurality of screens further comprises:
a compose message screen including a share a file command element from which the command to share the file is received.

19. The apparatus of claim 17, wherein the file explorer screen and the sharing option screen are separate interfaces.

20. The apparatus of claim 17, wherein the sharing option screen comprises the file explorer screen in which the first option and the second option surface after at least one file is selected in the file explorer screen.
